(19) United States
(12) Patent Application Publication
(10) Pub. No.: US 2017/0023218 A1
(43) Pub. Date: Jan. 26, 2017

(54) Lift Assembly And Related Method

(71) Applicants: Raymond Brown, Modesto, CA (US); Manuel Lopez, Lodi, CA (US)

(72) Inventors: Raymond Brown, Modesto, CA (US); Manuel Lopez, Lodi, CA (US)

(73) Assignee: USA Products Group, Inc., Lodi, CA (US)

(21) Appl. No.: 15/097,223

(22) Filed: Apr. 12, 2016

Related U.S. Application Data
(63) Continuation-in-part of application No. 14/806,609, filed on Jul. 22, 2015.

(51) Int. Cl. F21V 21/36; F16M 13/02

(52) U.S. Cl. CPC F21V 21/36; F16M 13/022

(57) ABSTRACT

A lift assembly having, among other things, a control mechanism in combination with one or more directional devices to facilitate efficient, versatile, and precise incremental leveling, securing, rising, and lowering of a platform, is disclosed herein.

### BACKGROUND

The present disclosure relates generally to a lift assembly, and more particularly to a lift assembly having, among other things, a control mechanism in combination with one or more directional devices to facilitate efficient, versatile, and precise incremental leveling, securing, rising, and lowering of a platform.

Lift assemblies have found useful application with horticulturists for indoor growing of among other things, plants, fruits, herbs, and vegetables. In this regard, indoor plant growth for decorative, food source, medicinal, or other purposes has become a very sophisticated activity with many improvements over the last decade. In addition to water and nutrients, light is an important element in the growth of plants. It has long been a common practice to use artificial light to mimic the natural outdoor light for indoor growing operations. Application of artificial light has been refined to such an extent that light, temperature, light wavelength, duration of the applied light, and the height in which the light is introduced above the desired target have all been studied and refined. Accordingly, the height of the light from the plant is critical, and continued fine adjust is often needed to maximize plant growth. It is not uncommon to adjust the height of the light source on a daily basis, all in an effort to maximize the growth cycle.

Currently, there are several different lift devices or assemblies on the market that allow the user to manually adjust the height of the artificial light relative to the plant. One such method utilizes a pair of locking rope device. In these assemblies the light is held in place and a pair of rope locking devices, common in the tie down industry or sold through hydroponic supply outlets, are secured to a platform having plants or other vegetation disposed thereon. The rope locking devices are positioned in such a manner to allow the user to lift and lower the platform.

However, these devices require the user to adjust the height of a first end or side of the platform using one of the rope locking devices, and subsequently adjust the height of the opposite or second end or side of the platform using the other rope locking device. This method of height adjust places the platform at an angled position after the first end is lifted and before the second end can be lift, potentially causing any object positioned on the platform to fall off the platform.

Accordingly, there is a need for an improved lift assembly having, among other things, a control mechanism in combination with one or more directional devices to facilitate efficient, versatile, and precise incremental leveling, securing, rising, and lowering of a platform.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a lift assembly comprises a control mechanism; multiple directional devices including a first directional device, a second directional device, and a third directional device; and a platform, wherein each of the control mechanism and multiple directional devices are connected by a strap in a two-by-two quadrant lift configuration, the control mechanism and one directional device positioned in upper quadrants, and the platform attached to the other two directional device in the lower quadrants, to facilitate level incremental rising and lower of the platform.

In another embodiment, a control mechanism for accepting a strap used for movement of an object is described. The control mechanism comprises an inner hub rotatably connected to the control mechanism, and configured to facilitate movement of the strap; a release-lock mechanism having a first pawl biased to contact the inner hub and configured to lock the inner hub in place to secure the object at a desired height, the first pawl configured to disengage from the inner hub when a counter bias force is applied; and a second pawl configured to contact the inner hub to lock the inner hub in place to secure the object at a desired height, the second pawl configured to disengage from the inner hub when a force is applied.

In still another embodiment, a lift assembly comprises a control mechanism; a first directional device, a first attachment mechanism, and a second attachment mechanism; and a platform, wherein each of the control mechanism, the first directional device, the first attachment mechanism, and the second attachment mechanism are connected by a strap in a two-by-two quadrant lift configuration, the control mechanism and the one directional device positioned in upper quadrants, and the platform attached to the attachment mechanisms in the lower quadrants to facilitate level incremental rising and lower of the platform.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1 shows a perspective view of a lift assembly in accordance with one embodiment disclosed herein.

FIG. 2 shows a cut-away view of a control mechanism of the lift assembly of FIG. 1 in accordance with one embodiment disclosed herein.

FIG. 3 shows another cut-away view of a control mechanism of the lift assembly of FIG. 1 in accordance with one embodiment disclosed herein.

FIG. 4 shows another perspective view of a lift assembly in accordance with another embodiment disclosed herein.

FIG. 5 shows one routing scheme of a strap for the lift assembly of FIG. 1, FIG. 4, and

FIG. 6.

FIG. 6 shows a perspective view of another lift assembly in accordance with one embodiment disclosed herein.

FIG. 7 shows a control mechanism of the lift assembly of FIG. 6 in accordance with one embodiment disclosed herein.

FIG. 8 shows another cut-away view of a control mechanism shown in FIG. 7 of the lift assembly of FIG. 6 in accordance with one embodiment disclosed herein.

FIG. 9 shows another cut-away view of a control mechanism shown in FIG. 7 of the lift assembly of FIG. 6 in accordance with one embodiment disclosed herein.

FIG. 10 shows another cut-away view of a control mechanism shown in FIG. 7 of the lift assembly of FIG. 6 in accordance with one embodiment disclosed herein.

FIGS. 11-13 show a handle assembly of the lift assembly of FIG. 6 in accordance with one embodiment disclosed herein.

FIG. 14 is a parts view of the lift assembly of FIG. 6 in accordance with one embodiment disclosed herein.

FIG. 15 shows perspective view of another lift assembly in accordance with one embodiment disclosed herein.

### DETAILED DESCRIPTION

Exemplary embodiments will now be described with references to the accompanying figures, wherein like reference numbers refer to like elements throughout. The terminology used in the description presented herein in not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a lift assembly, and more particularly to a lift assembly having, among other things, a control mechanism in combination with multiple directional devices to facilitate efficient, versatile, and precise incremental leveling, securing, rising, and lowering of a platform.

As used herein, the term “hub” is intended to include a spindle, a spool, a sheave, or a similar type article(s) that is configured or may be adapted to permit rotation and facilitate movement of a “strap” used for the purpose of leveling, securing, rising, and lowering a “platform”.

As used herein, the term “strap” is intended to include a line, a rope (round synthetic, natural fiber, metal), a cable, a cord, a flat line (webbing), an anchor line or tensioning line, or a similar type of article(s) that may be adapted to be used with the lift assembly disclosed herein for the purpose of leveling, securing, rising, and lower a platform.

As used herein, in one embodiment the term “platform” is intended to include any surface or object that is generally used to hold or otherwise have position thereon items of one form or another including, but not limited to plants, fruits, herbs, and vegetables positioned below a light source. In another embodiment, platform may refer to a “light source” positioned above items including but not limited to plants, fruits, herbs, and vegetables.

Various parts, elements, components, etc, of the lift assembly disclosed herein may be constructed from metal, plastic, composite, or other suitable material or combination thereof for providing a sturdy and reliable structure for the purpose of leveling, securing, rising, and lowering a platform.

The actual size and dimension of any and all of the various parts, elements, components, etc., may vary depending on various factors including, among other things, intending application or usage of the lift assembly, as well as the size of the platform and/or items placed thereon and intended to be leveled, secured, raised, and lowered.

Connection(s) between the various parts, elements, components, etc., of the lift assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

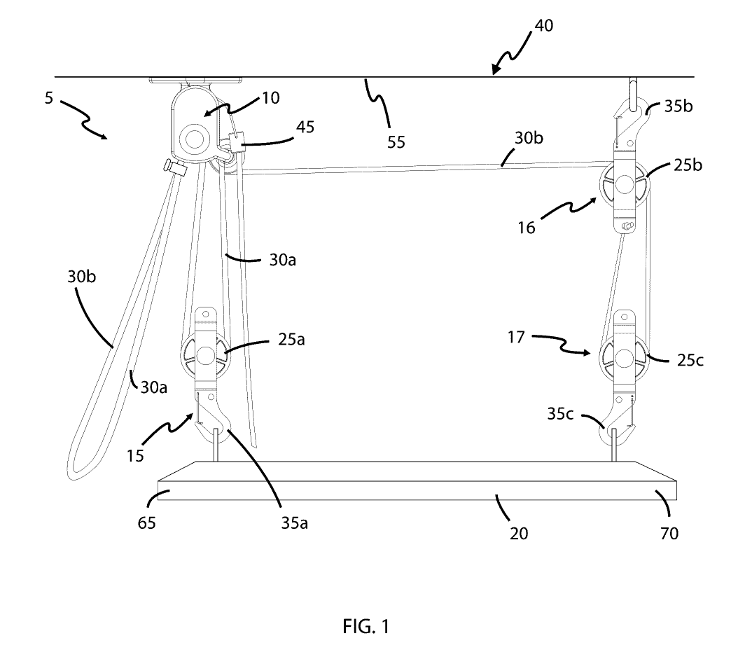

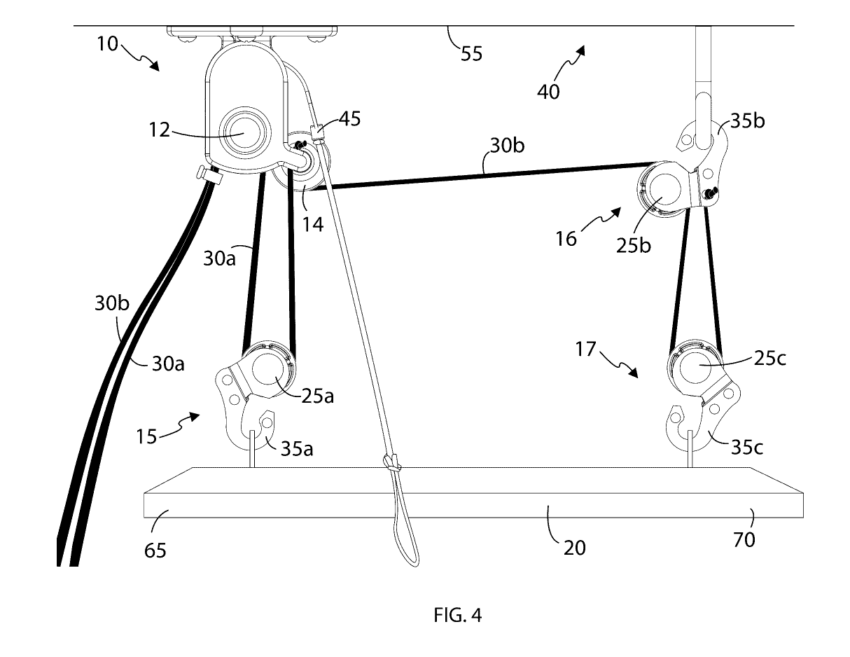

FIG. 1 and FIG. 4 each show a lift assembly 5 in accordance with an embodiment disclosed herein. In this regard, the general features of the lift assembly 5 disclosed below relative to FIG. 1 apply equally to the lift assembly disclosed relative to FIG. 4 with each including multiple directional device with the directional devices of FIG. 1 being of a linear configuration (structure) and the directional devices of FIG. 4 being an L-shape configuration (structure).

The subject matter of the lift assembly 5 is disclosed below with a platform 20 configured to hold various forms of plants (not shown) positioned below a light source 55. In this regard, the lift assembly 5 is configured to precisely level, secure, rise, and lower the platform 20 relative to the light source 55. However, in another embodiment, the light source 55 may be substituted for the platform 20 or the platform 20 can be configured to include or incorporate a light source 55. Accordingly, the lift assembly 5 may be configured to precisely level, secure, rise, and lower the light source 55 relative to the various forms of plants positioned below the platform 55 (light source).

The lift assembly 5 may include a control mechanism 10 in combination with a multiple directional devices 15, 16, 17 to facilitate efficient, versatile, and incremental leveling, securing, rising, and lowering of a platform 20. In the embodiment disclosed herein, three directional device having substantially the same in size, structure, and function are utilized, but persons of ordinary skill in the art will understand that the directional devices may be of different sizes and still provide the benefits and functionality of the lift assembly as disclosed herein.

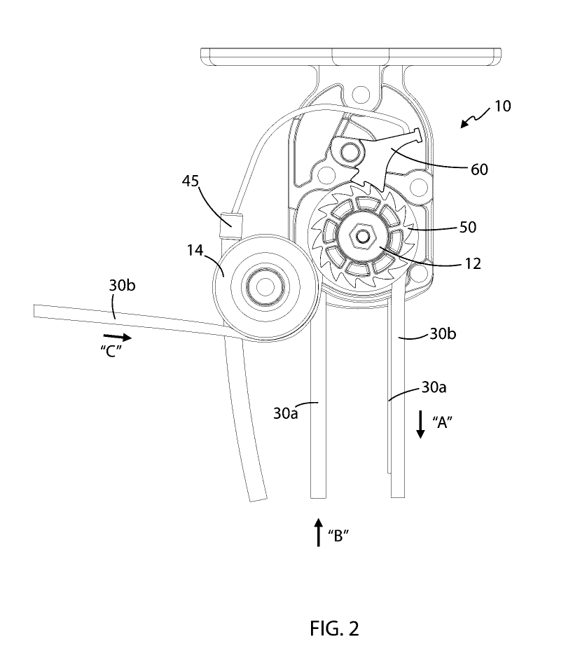

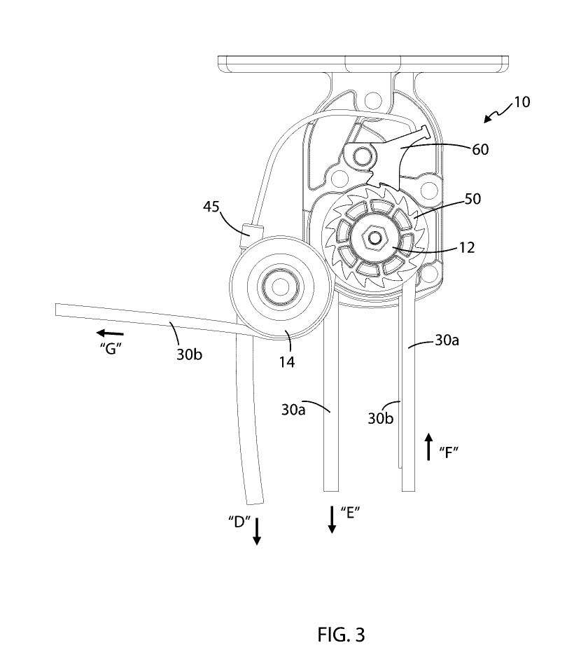

In this regard, the lift assembly 5 may include a first directional device 15, a second directional device 16, and a third directional device 17. As shown in FIG. 2, in one embodiment, the control mechanism 10 may include an inner hub 12 and an outer hub 14 configured or adapted to permit rotation and facilitate movement of a first strap 30a and a second strap 30b used for the purpose of leveling, securing, rising, or lowering the platform 20. The control mechanism may further include a release-lock mechanism 45 (lanyard or other draw string type device) having a pawl 60 configured to release or lock the inner hub 12 in place to secure the platform 20 at a desired height or vertical elevation. In this regard, as shown in FIG. 2, the pawl 60 of the release-lock mechanism 45 is biased to engage teeth 50 on the inner hub 12 to prohibit rotation of the inner hub 12. As shown in FIG. 3, pulling on the first strap 30a and the second strap 30b disengages the pawl 60 of the release-lock mechanism 45 from the teeth 50 of the inner hub 12 permitting the inner hub 12 to rotate and allow precise incrementally leveling, raising and lowering of the platform 20 to a desired height the platform 20.

Each directional device 15, 16, 17 includes a corresponding hub 25a, 25b, 25c configured or adapted to permit rotation and facilitate movement of the first strap 30a or the second strap 30b used for the purpose of leveling, securing, rising, and lowering the platform 20, and a corresponding hook 35a, 35b, 35c or similar mechanism for attaching or otherwise securing the corresponding directional device 15-17 to the platform 20 or other stationary object 40 such as a ceiling or overhang.

As shown in FIG. 1 and FIG. 2, the first strap 30a may be routed over the inner hub 12 of the control mechanism 10, between the inner hub 12 and the outer hub 14 of the control mechanism 10, down toward and around the bottom of the hub 25a of the first directional device 15, and up to the outer hub 14 of the control mechanism 10 where the strap 30a is tied off or otherwise secured. The second strap 30b may be routed over the inner hub 12 of the control mechanism 10, between the inner hub 12 and the outer hub 14 of the control mechanism 10, toward and over the top of the hub 25b of the second directional device 16, down toward the hub 25c of the third directional device 17, around the bottom of the hub 25c of the third directional device 17, and up to the second directional device 16 where the strap 30b is tied off or otherwise secured. In this regard, the control mechanism 10 and the three multiple directional devices 15-17 may be connected by the first strap 30a and a second strap 30b in a two-by-two (2×2) quadrant lift configuration with the control mechanism 10 and one directional device 16 in upper quadrants, and the platform 20 attached to the other two directional device 15, 17 in the lower quadrants.

As further shown in FIG. 1, the control mechanism 10 may be secured to a stationary object 40 such as a ceiling or overhang, while the first directional device 15 is positioned generally in a vertical direction from the control mechanism 10 and secured to a first end 65 of the platform 20. The second directional device 16 is positioned generally horizontal to the control mechanism 10 and secured to the stationary object 40, while the third directional device 17 is positioned generally in a vertical direction from the second directional device 16 and secured to a second end 70 the platform 20. A light source 55 is disposed on the stationary object 40 above the platform 20. Accordingly, the platform 20 is secured in a generally horizontal (level) position below the light source 55 by the control mechanism 10, and combination of first directional device 15, second directional device 16, and third directional device 17.

As shown in FIG. 2, due to the routing of the first strap 30a and second strap 30b as disclosed above, applying a force (pulling) to the first strap 30a and the second strap 30b in a direction shown by arrow “A” causes the first strap 30a to move in a direction generally shown by arrow “B”, and the second strap 30b to move in a direction generally shown by arrow “C” to rise the platform in a precise incremental manner. Biasing of the pawl 60 of the release-lock mechanism 45 secures the platform 20 at the desired height and a distance relative to the light source 55. As shown in FIG. 3, applying a force (pulling) to the release-lock mechanism 45 in a direction generally shown by arrow “D” disengages the pawl 60 from the teeth 50 of the inner hub 12 permitting the inner hub 12 to rotate, the first strap 30a to move in a direction generally shown by arrows “E” and “F”, the second strap 30b to move in a direction generally shown by arrow “G”. Such an arrangement and routing of the first strap 30a and second strap 30b allows simultaneous precise incrementally leveling, raising and lowering of the first end 65 of the platform 20 and the second end 70 of the platform 20 to a desired height relative to the light source 55.

The first strap 30a and second strap 30b are in close proximity and can be easily handled by the user with one hand to either pull the straps 30a, 30b to raise up, or to feed in straps 30a, 30b, to lower the platform 20. When using similar sized directional devices 15-17, the position of the first end 65 of the platform 20 and second end 70 of the platform 20 simultaneously moves up or down in unison, thus, keeping the platform 20 level. Alternatively, if desired, either the first strap 30a or the second strap 30b could be move independently to alter the angle of the platform 20. The attachment points of the control mechanism 10 and directional devices 15-17 are adjustable to accommodate a variety of platforms and light fixture widths and shapes.

As disclosed herein, the release-lock mechanism 45 that, when pulled down, disengages a biased pawl 60 from the teeth 50 of inner hub 12 to allow free rotation of the inner hub 12 in both directions. Release of the release-lock mechanism 45 would reengage the biased pawl 60 into the inner hub 12 to prevent unwanted, downward movement of the platform 20 or light source 55. Therefore, pulling on the first strap 30a and the second strap 30b at the same time would result in raising the platform 20 or light source 55, and allow efficient, versatile, and precise incremental leveling, securing, rising, and lowering of the platform 20 or light source 55 by the user.

Conversely, lowering of the platform 20 or light source 55 device precisely done by providing an initial force on the release-load mechanism 45 to disengage the biased pawl 60 from the inner hub 12 then allowing the first strap 30a and the second strap 30b to route through the control mechanism 10 as the weight of the platform 20 of light source 55 provides tension to the straps 30a, 30b allowing precise lowering of the platform 20 or light source 55.

Accordingly, a lift assembly 5 method of lifting a platform 20 or light source 55 includes routing a first strap 30a and a second strap 30b in a lift assembly 5 having a control mechanism 10 and three directional device 15-17 formed in a two-by-two quadrant lift configuration, the control mechanism 10 and one directional device 16 positioned in upper quadrants, and the other two directional device in the lower quadrants; attaching a platform to the first directional device 15 and the third directional device 17; and simultaneously applying a force to the first strap 30a and second strap 30b to facilitate level incremental rising and lower of the platform 20.

The lift assembly method may further include positioning the first directional device 15 generally in a vertical direction from the control mechanism 10, securing the first directional device 15 to the platform 20, positioning the second directional device 16 generally horizontal to the control mechanism 10, securing the second directional device 16 to the stationary object 40 positioning the third directional device 17 generally in a vertical direction from the second directional device 16, and securing the third directional device 17 to the platform 20.

The lift assembly method may further include routing the first strap 30a through the control mechanism 10, down to the first directional device 15, back to the control mechanism 10, and securing the first strap 30a to the control mechanism 10, and routing the second strap 30a through the control mechanism 10, across to the second directional device 16, down to the third directional device 17, back to the second directional device 16, and securing the second strap 30b to the second directional device 16.

The lift assembly method may further include routing the first strap 30a over the inner hub 12 of the control mechanism 10, between the inner hub 12 and the outer hub 14 of the control mechanism 10, down toward and around the bottom of the hub 25a of the first directional device 15, and up to the outer hub 14 of the control mechanism 10 where the first strap 30a is secured, and routing the second strap 30b over the inner hub 12 of the control mechanism 10, between the inner hub 12 and the outer hub 14 of the control mechanism 10, toward and over the top of the hub 25b of the second directional device 16, down toward the hub 25c of the third directional device 17, around the bottom of the hub 25c of the third directional device 17, and up to the second directional device 16 where the second strap 30b is secured.

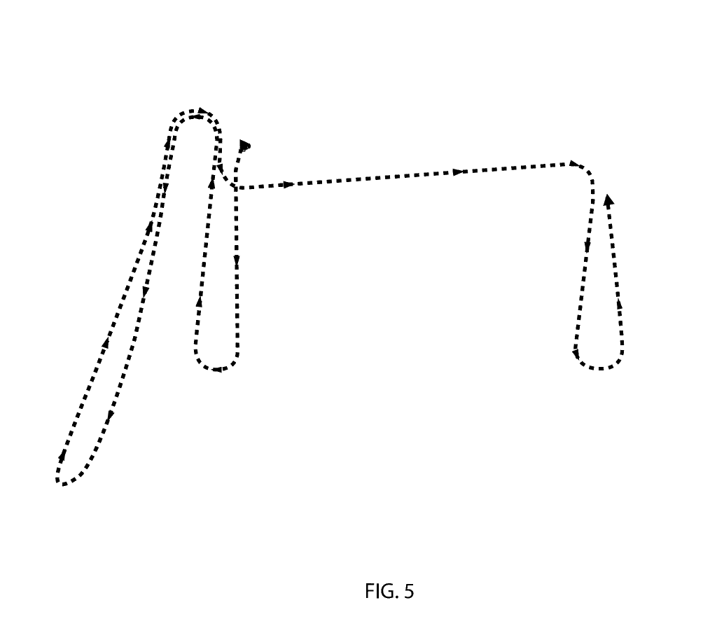

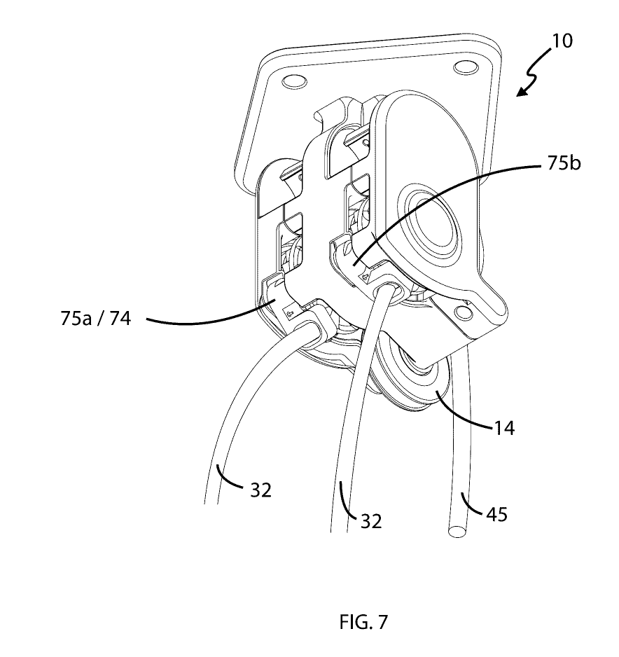

As shown in FIG. 5, an alternative cord routing scheme utilizes a single strap 32 that is tied off or otherwise secured to the outer hub 14 of the control mechanism 10. The strap 32 is then routed or threaded downward toward the first directional device 15, around the hub 25a of the first directional device 15, upward to the control mechanism, and around the inner hub 12 of the control mechanism. The strap 32 is passed out of the control mechanism 10. A loop is then formed in the strap 32 and the strap 32 is routed back to the control mechanism 10 (see FIG. 7 that shows the routing of the strap 32 out of the control mechanism 10 and back into the control mechanism 10) where the strap 32 is passed over the inner hub 12, between the inner hub 12 and the outer hub 14, under the outer hub 14, and toward the second directional device 16. The strap 32 is then passed over the hub 25b of the second directional device 16, downward toward the third directional device 17, around the bottom of the hub 25c of the third directional device 17, and upward to the second directional device 16 where the strap 32 is tied off or otherwise secured. Those skilled in the art will understand that the strap 32 may be alternatively routed by initially having the strap 32 tied off or otherwise secured at the second directional device 16 and routed downward toward the third directional device 17, and continuing in a manner opposite to the process just described.

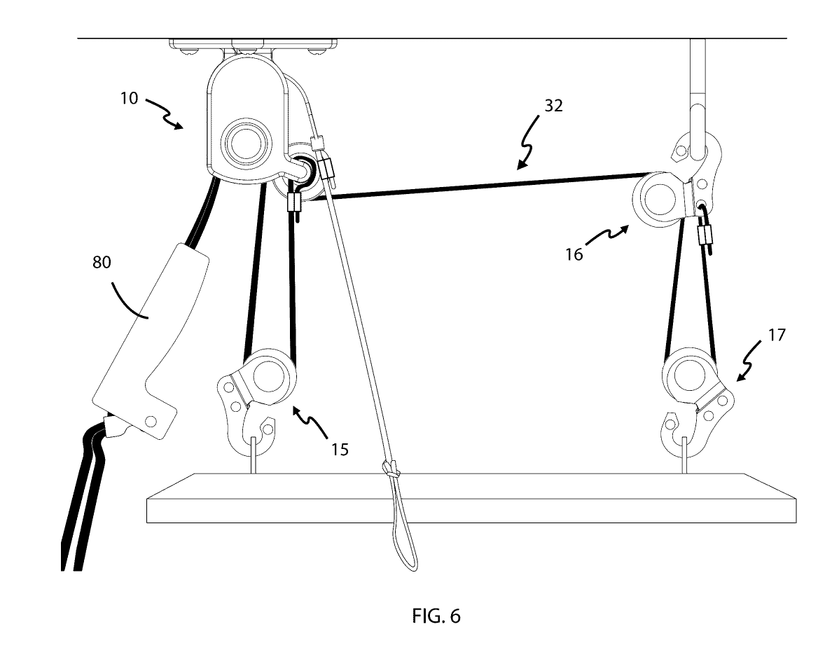

FIG. 6 shows a perspective view of another lift assembly in accordance with one embodiment disclosed herein. The lift assembly of FIG. 6 is similar to the lift assembly of

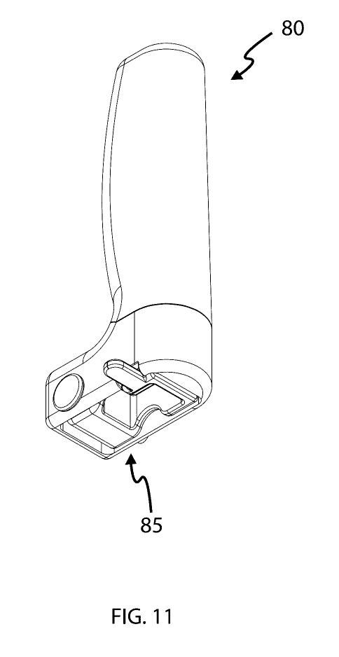

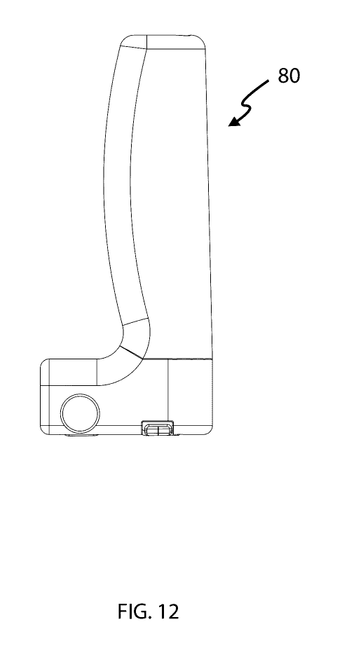

FIG. 4 with noted differences. These differences include a second pawl 74 or a pair of pawls 75a and 75b configured to release or lock the inner hub 12 in place to secure the platform or object 20 at a desired height or vertical elevation (see FIGS. 7-10), a handle assembly 80 having a swing lock mechanism 85 for locking or otherwise securing the strap 32 in place (see FIGS. 11-12), and the single strap 32 having the routing scheme as shown in the FIG. 5. As shown in FIG. 6, the directional devices have an L-shape configuration (structure), but otherwise function similar to the linear shaped structural configuration of the directional devices of FIG. 1.

In this regard, the lift assembly 5 may include a first directional device 15, a second directional device 16, and a third directional device 17. The control mechanism 10 may include an inner hub 12 rotatably connected the control mechanism 10, and an outer hub 14 positioned relative to the inner hub 12 and configured or adapted to permit rotation and facilitate movement of the strap 32 used for the purpose of leveling, securing, rising, or lowering the platform 20. The control mechanism may further include a release-lock mechanism 45 having a pawl 60, herein also referred to as a first pawl 60, configured to release or lock the inner hub 12 in place to secure the platform 20 at a desired height or vertical elevation. The first pawl 60 of the release-lock mechanism 45 is biased to contact or engage the teeth 50 on the inner hub 12 to prohibit rotation or lock the inner hub 12 in place to secure the platform or object 20 at a desired height. The first pawl 60 is further configured to disengage from the teeth 50 of the inner hub 12 when a force, counter to the bias force, is applied.

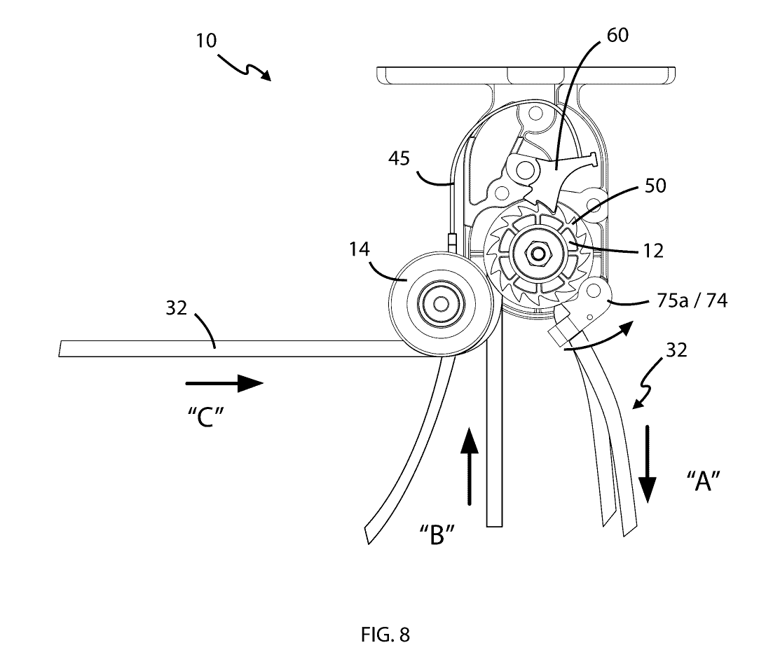

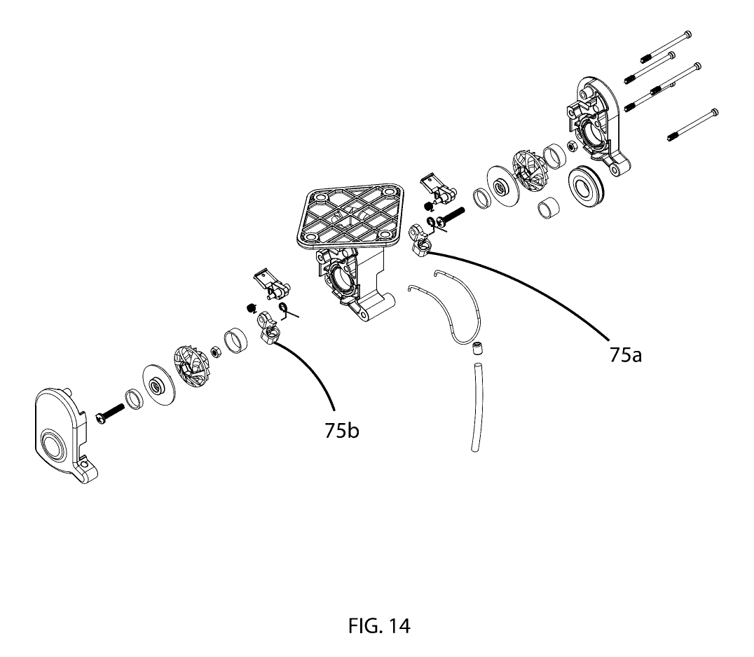

As shown in FIG. 8, pulling on the strap 32 disengages the first pawl 60 of the release-lock mechanism 45 from the teeth 50 of the inner hub 12 permitting the inner hub 12 to rotate and allow precise incrementally leveling, raising and lowering of the platform or object 20 to a desired height the platform 20. In contrast to the control mechanism 10 shown in FIG. 2-3, the control mechanism shown in FIGS. 6-10 includes a second pawl 74 or a pair of pawls 75a and 75b, best shown in FIG. 7 and also shown in the parts view of FIG. 14, positioned on opposite sides of the inner hub 12 to engage the teeth 50 of the inner hub 12.

In this regard, although the subject matter is described has having a pair of pawls 75a, 75b, in another example the control mechanism 10 includes a second pawl or single pawl 74 that functions essential the same as the pair of pawls 75a, 75b. Furthermore, as best shown in FIG. 7, the strap 32 is routed through orifices formed in the pair of pawls 75a, 75b. Accordingly, as described above in reference to FIG. 5, the strap 32 is routed out of the control mechanism 10 by way of one of the pawls of the pair of pawls 75s, and back into the control mechanism 10 by way of the other pawl of the pair of pawls 75b. Alternatively, if only a single pawl or second pawl 74 is utilized, the strap 32 would either exit or enter the control mechanism 10 by way of the second pawl 74.

In this regard, the pair of pawls 75a, 75b work independently of the first pawl 60 connected to the release-lock mechanism 45 and engaged with the inner hub 12. When the release-lock mechanism 45 is pulled to disengage the first pawl 60 from the teeth 50 of the inner hub 12, the pair of pawls 75a, 75b act as a secondary engagement means on the teeth 50 of the inner hub 12 to prevent unwarranted tension release. In this regard, the pair of pawls 75a, 75b are configured to engage or contact the teeth 50 of the inner hub 12 to lock the inner hub 12 in place to secure the platform or object 12 at a desired height. The pair of pawls 75a, 75b are further configured to disengage from the teeth 50 of the inner hub 12 when a force is applied.

As shown in FIG. 8, due to the routing of the strap 32 as disclosed above, applying a force to the strap 32 in a direction shown by arrow “A” causes the strap 32 to move in a direction generally shown by arrow “B”, causing the pair of pawls 75a (75b not shown, but on the opposite side of 75a) to disengage from the teeth 50 of the inner hub 12 and cause the strap 32 to move in a direction generally shown by arrow “C” to rise or lift the platform or object 20 in a precise incremental manner. Biasing of the pawl 60 of the release-lock mechanism 45 secures the platform 20 at the desired height and a distance relative to the light source 55.

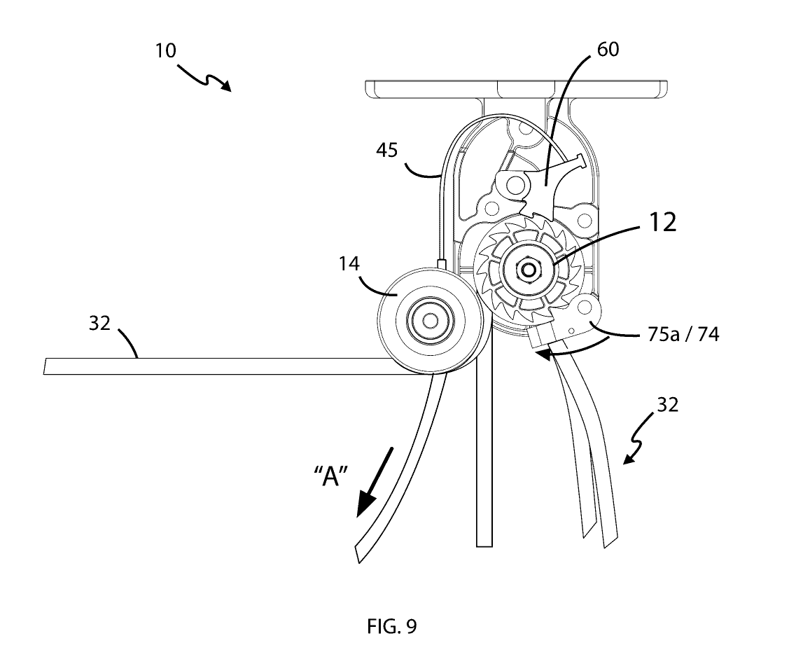

As shown in FIG. 9, the first pawl 60 is normally biased to engage the teeth 50 of the inner hub 12. When a force (pulling) as shown by arrow “A” is applied to the release-lock mechanism 45, the first pawl 60 is disengaged from the teeth 50 of the inner hub 12. However, as further shown in FIG. 9, after the platform is raised or lifted the strap 32 is moved to engage the pair of pawls 75a, 75b with the inner hub 12 to prevent the unwarranted release of tension.

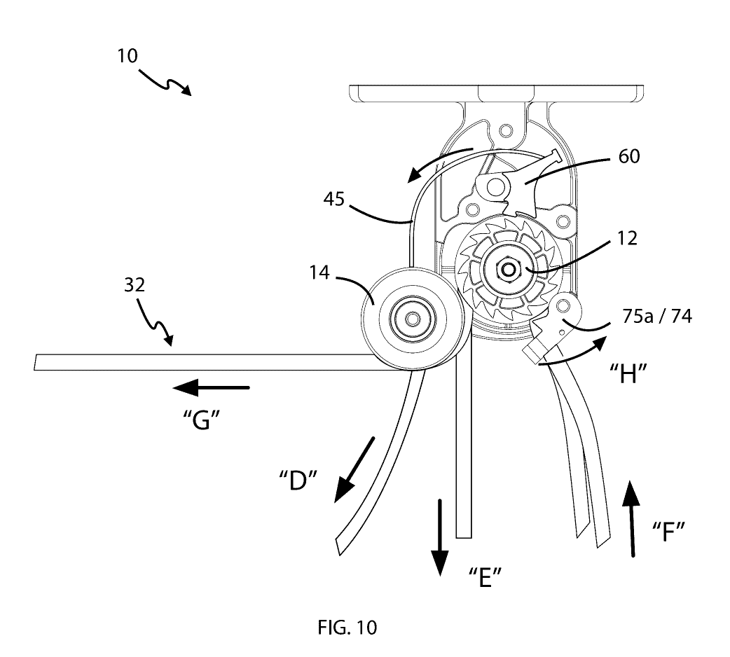

As shown in FIG. 10, applying a force to the release-lock mechanism 45 in a direction generally shown by arrow “D” and release of the pair of pawls 75a, 75b by applying a force to the strap 32 the general direction shown by arrow “H”, disengages the first pawl 60 and the pair of pawls 75a, 75b from the teeth 50 of the inner hub 12 permitting the inner hub 12 to rotate, and the strap 32 to move in a direction generally shown by arrows “E” and “F”. The strap 32 is further caused to move in a direction generally shown by arrow “G”. Such an arrangement and routing of the strap 32 allows simultaneous precise incrementally leveling, raising and lowering of the first end 65 of the platform 20 and the second end 70 of the platform 20 to a desired height relative to the light source 55. Accordingly, as can be appreciated from the disclosed subject matter, the first pawl 60 and pair of pawls 75, 75b, or second pawl 74 are configured to do all of the following, but can only do one of the following at any given time: (1) both lock the inner hub in place at the same time, (2) the first pawl locks the inner hub in place and the second pawl disengages from the inner hub, (3) the first pawl disengages from the inner hub and the second pawl engages the inner hub, or (4) both the first pawl and the second pawl disengage from the inner hub.

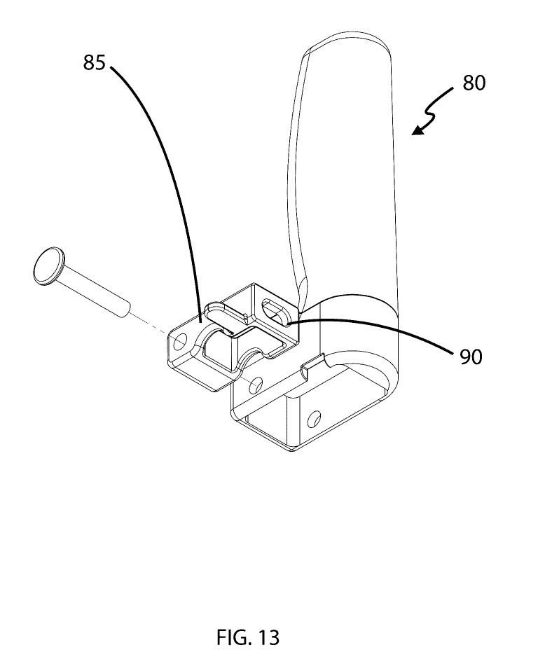

As indicated above, as shown in FIGS. 11-13, the lift assembly 10 includes a handle assembly 80 (see FIG. 6). The handle assembly 80 acts as a strap or cord management assembly making it easier and more efficient for the user to manage more than one strap 32 that is the loop end of the strap 32. The handle assembly 80 includes a swing lock mechanism 85 for locking or otherwise securing the strap 32 in place. In this regard, the strap(s) 32 are passed through an orifice 90 (see FIG. 13) in the swing lock mechanism 85 and exit from the bottom of the handle assembly 80. In operation, the handle assembly 80 is raised on the straps 32 and then pulled down to draw strap 32 out of the bottom of the handle assembly 80 and raise the platform 20. Pulling down on the handle assembly 80 causes the swing lock mechanism 85 to rotate until the swing lock mechanism 85 contacts the sidewall of the handle assembly 80. As the swing lock mechanism contacts the sidewall of the handle assembly 80 the straps 32 are wedged into a temporary secured or locked position. In the locked position, both the handle assembly 80 and the release-lock mechanism 45 can be pulled with one hand by the user.

Pulling on the strap ends cause the the swing lock mechanism 45 to rotate away from the locked position to free the straps to move in the orifice 90 of the handle assembly 80 and allow the straps 32 to move out of the top of the handle assembly 80 and lower the platform 20.

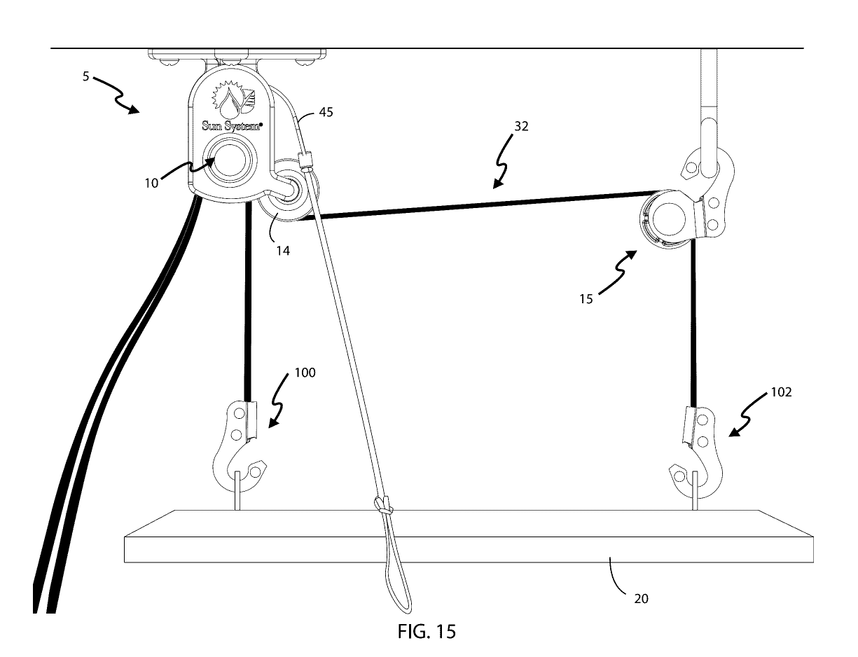

FIG. 15 a perspective view of another lift assembly in accordance with one embodiment disclosed herein. The lift assembly 5 includes a control mechanism 10, a first directional device 15 having an L-shaped configuration, a first attachment mechanism 100, and a second attachment mechanism 102. The first attachment mechanism 100 and second attachment mechanism 102 may be an attachment or securing mechanism such as a hook, brace, or similar type hardware configured to connect to the platform 20 and secure the strap 32. The configuration of the first directional device 15, first attachment mechanism 100, and second attachment mechanism 102 provides a simple and efficient structure for the purpose of leveling, securing, rising, or lowering a platform 20. The lift assembly 5 shown in FIG. 15 utilizes a single strap 32 routing scheme.

In this regard, a single strap 32 that is tied off or otherwise secured to the first attachment mechanism 100. The strap 32 is then routed upward toward the control mechanism 10, and around the inner hub 12 of the control mechanism. The strap 32 is passed out of the control mechanism 10. A loop is then formed in the strap 32 and the strap 32 is routed back to the control mechanism 10 (see FIG. 7 that shows the routing of the strap 32 out of the control mechanism 10 and back into the control mechanism 10) where the strap 32 is passed over the inner hub 12, between the inner hub 12 and the outer hub 14, under the outer hub 14, and toward the first directional device 15. The strap 32 is then passed over the hub of the first directional device 15, and downward toward the second attachment mechanism 102 where the single strap 32 is tied off or otherwise secured. Those skilled in the art will understand that the single strap 32 may be alternatively routed by initially having the strap 32 tied off or otherwise secured at the second attachment mechanism 102 and routed upward toward the first directional device 15, and continuing in a manner opposite to the process just described.

The control mechanism 10 of the lift assembly 5 may include an inner hub 12 rotatably connected the control mechanism 10, and an outer hub 14 positioned relative to the inner hub 12 and configured or adapted to permit rotation and facilitate movement of the strap 32 used for the purpose of leveling, securing, rising, or lowering the platform 20. The control mechanism may further include a release-lock mechanism 45 having a pawl 60 (see FIG. 8), herein also referred to as a first pawl 60, configured to release or lock the inner hub 12 in place to secure the platform 20 at a desired height or vertical elevation. The first pawl 60 of the release-lock mechanism 45 is biased to contact or engage the teeth 50 on the inner hub 12 to prohibit rotation or lock the inner hub 12 in place to secure the platform or object 20 at a desired height. The first pawl 60 is further configured to disengage from the teeth 50 of the inner hub 12 when a force, counter to the bias force, is applied.

Similar to the lift assembly of FIG. 6, the control mechanism 10 of the lift assembly of FIG. 15 may include a second pawl 74 or a pair of pawls 75a and 75b configured to release or lock the inner hub 12 in place to secure the platform or object 20 at a desired height or vertical elevation (see FIGS. 7-10), and a handle assembly 80 having a swing lock mechanism 85 for locking or otherwise securing the strap 32 in place (see FIGS. 11-12) may be further included.

As such, the subject matter disclosed herein provides for an improved lift assembly having, among other things, a control mechanism in combination with multiple directional devices to facilitate efficient, versatile, and precise incremental leveling, securing, rising, and lowering of a platform.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A lift assembly comprising:
a control mechanism;
multiple directional devices including a first directional device, a second directional device, and a third directional device; and
a platform,
wherein each of the control mechanism and multiple directional devices are connected by a strap in a two-by-two quadrant lift configuration, the control mechanism and the one directional device positioned in upper quadrants, and the platform attached to the other two directional device in the lower quadrants to facilitate level incremental rising and lower of the platform.

2. The lift assembly of claim 1, wherein the control mechanism is secured to a stationary object, the first directional device is positioned generally in a vertical direction from the control mechanism and secured to the platform, the second directional device is positioned generally horizontal to the control mechanism and secured to the stationary object, and the third directional device is positioned generally in a vertical direction from the second directional device and secured to the platform.

3. The lift assembly of claim 1, wherein the control mechanism includes an inner hub, and outer hub configured to permit rotation and facilitate movement of the strap; and a release-lock mechanism having a biased pawl configured to release or lock the inner hub in place to secure the platform at a desired height.

4. The lift assembly of claim 1, wherein the each of the directional devices include a corresponding hub configured to permit rotation and facilitate movement of the strap; and a corresponding attachment mechanism for securing the corresponding directional device to the platform or a stationary object.

5. The lift assembly of claim 1, wherein the control mechanism includes an inner hub, and outer hub configured to permit rotation and facilitate movement of the strap; and a release-lock mechanism having a biased pawl configured to release or lock the inner hub in place to secure the platform at a desired height, and
wherein the each of the directional devices include a corresponding hub configured to permit rotation and facilitate movement of the first strap or the second strap; and a corresponding attachment mechanism for securing the corresponding directional device to the platform or a stationary object.

6. The lift assembly of claim 2, furthering including a light source disposed on the stationary object between the control mechanism and the second directional device.

7. A lift assembly comprising:
a control mechanism;
a first directional device, a first attachment mechanism, and a second attachment mechanism; and
a platform,
wherein each of the control mechanism, the first directional device, the first attachment mechanism, and the second attachment mechanism are connected by a strap in a two-by-two quadrant lift configuration, the control mechanism and the one directional device positioned in upper quadrants, and the platform attached to the attachment mechanisms in the lower quadrants to facilitate level incremental rising and lower of the platform.

8. The lift assembly of claim 7, wherein the control mechanism is secured to a stationary object, the first directional device is positioned generally in a horizontal direction from the control mechanism and secured to the stationary object, the first attachment mechanism is positioned generally horizontal to the control mechanism and secured to the platform, and the second attachment mechanism is positioned generally in a vertical direction from the first directional device and secured to the platform.

9. The lift assembly of claim 7, wherein the control mechanism includes an inner hub, and outer hub configured to permit rotation and facilitate movement of the strap; and a release-lock mechanism having a biased pawl configured to release or lock the inner hub in place to secure the platform at a desired height.

10. The lift assembly of claim 7, wherein the first directional devices include a corresponding hub configured to permit rotation and facilitate movement of the strap; and a corresponding attachment mechanism for securing the corresponding directional device to the platform or a stationary object.

11. A lift assembly method of lifting a platform comprising:
routing a strap through a lift assembly having a control mechanism and multiple directional devices including a first directional device, a second directional device, and a third directional device formed in a two-by-two quadrant lift configuration,
wherein the control mechanism and one directional device are positioned in upper quadrants, and the other two directional device are positioned in the lower quadrants;
attaching a platform to the first directional device and the third directional device; and
simultaneously applying a force to the strap to facilitate level incremental rising and lowering of the platform.

12. The lift assembly method of claim 11, further comprising:
positioning the first directional device generally in a vertical direction from the control mechanism;
securing the first directional device to the platform;
positioning the second directional device generally horizontal to the control mechanism;
securing the second directional device to a stationary object;
positioning the third directional device generally in a vertical direction from the second directional device; and
securing the third directional device to the platform.

13. The lift assembly method of claim 11, further comprising:
disposing a light source on the stationary object between the control mechanism and the second directional device.

14. The lift assembly method of claim 11, wherein the platform is a light source.

15. A control mechanism for accepting a strap used for movement of an object, the control mechanism comprising:
an inner hub rotatably connected to the control mechanism, and configured to facilitate movement of the strap;
a release-lock mechanism having a first pawl biased to contact the inner hub and configured to lock the inner hub in place to secure the object at a desired height, the first pawl configured to disengage from the inner hub when a counter bias force is applied; and
a second pawl configured to contact the inner hub to lock the inner hub in place to secure the object at a desired height, the second pawl configured to disengage from the inner hub when a force is applied.

16. The control mechanism of claim 15, including an outer hub position relative to the inner hub and configured to further movement of the strap.

17. The control mechanism of claim 15, wherein the first pawl and second pawl are configured to do all of the following, but can only do one of the following at any given time: (1) both lock the inner hub in place at the same time, (2) the first pawl locks the inner hub in place and the second pawl disengages from the inner hub, (3) the first pawl disengages from the inner hub and the second pawl engages the inner hub, or (4) both the first pawl and the second pawl disengage from the inner hub.
